(19) United States
(12) Patent Application Publication
(10) Pub. No.: US 2015/0215633 A1
(43) Pub. Date: Jul. 30, 2015

(54) IMAGE-DATA BINARY ARITHMETIC DECODING DEVICE AND IMAGE DECODING DEVICE

(71) Applicant: NEC Corporation, Minato-ku, Tokyo (JP)

(72) Inventor: Keiichi Chono, Tokyo (JP)

(73) Assignee: NEC Corporation, Minato-ku, Tokyo (JP)

(21) Appl. No.: 14/422,217

(22) PCT Filed: Aug. 21, 2013
(86) PCT No.: PCT/JP2013/004941

§ 371 Date: Feb. 18, 2015

(30) Foreign Application Priority Data
Aug. 22, 2012 (JP) 2012-183229

(51) Int. Cl. H04N 19/44; H04N 19/13; H04N 19/91

(52) U.S. Cl. CPC H04N 19/44; H04N 19/91; H04N 19/13

(57) ABSTRACT

An image-data binary arithmetic decoding device binary arithmetic decodes a binary string in which continuous 1s and a terminating 0 constitute a prefix. The image-data binary arithmetic decoding device includes continuous-one number determination means for comparing a range of binary arithmetic decoding and a binary arithmetic decoding offset obtained through looking ahead N bits from a bitstream where N is a natural number, and determining the number of continuous 1s in a binary string of the N bits.

### TECHNICAL FIELD

The present invention relates to an image decoding device for decoding a bitstream that is compressed by an image coding scheme for binary arithmetic coding binary data using a fixation probability.

### BACKGROUND ART

Regarding High Efficiency Video Coding (HEVC) which is a successor standard to H.264/MPEG-4 Advanced Video Coding (AVC), Non Patent Literature (NPL) 1 specifies the following: a differential motion vector (abs_mvd_minus2) and a coefficient vector (coeff_abs_level_remaining) are each represented by a binary string, and each bin of the binary string is coded by binary arithmetic coding using a fixation probability (hereafter referred to as bypass coding). The fixation probability is 0.5 for each of a symbol “1” and a symbol “0”.

A coded output corresponding to one bin is 1 bit. The length of the binary string thus determines the number of bits of the syntax, that is, the compression performance of the syntax. To enhance the compression performance of the syntax, HEVC uses variable length codes for the binary string representation of the syntax.

FIG. 7 is an explanatory diagram showing a binary string for each value of abs_mvd_minus2. In FIG. 7, “1” and “0” in the shaded boxes each represent a bin in a prefix, and “1” and “0” in the non-shaded boxes each represent a bin in a suffix. As shown in FIG. 7, the binary string is a variable length code made up of: a prefix having continuous “1”s and a terminating “0”; and a suffix having the same number of bits as the number of “1”s in the prefix (NumPrefixOnes).

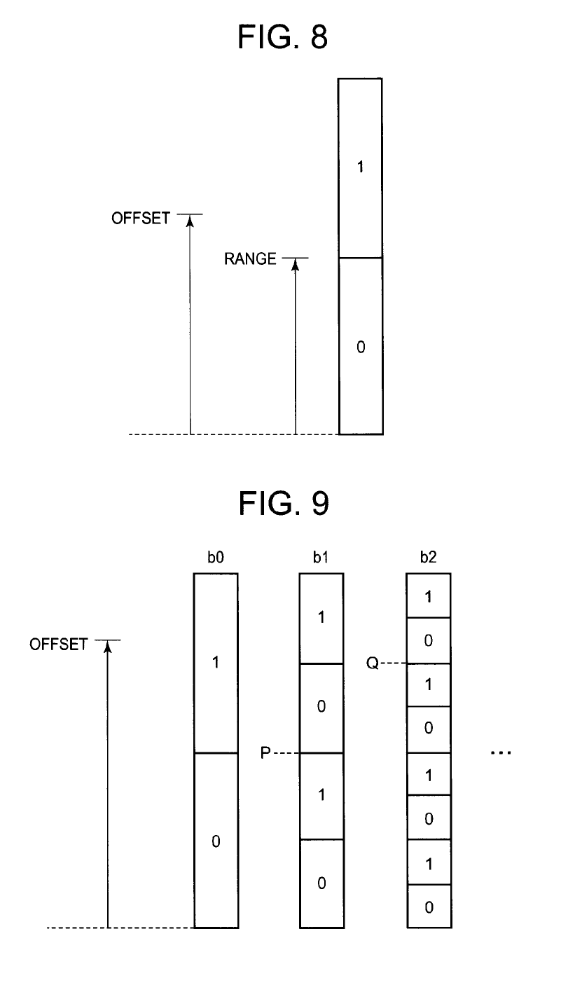

FIG. 8 is an explanatory diagram showing a process of decoding a bin from a bitstream compressed by bypass coding. Such a decoding process, i.e. binary arithmetic decoding using a fixation probability, is hereafter referred to as bypass decoding. A range shown in FIG. 8 is each probability section (probability width) in the arithmetic coding process and the arithmetic decoding process. The range is the interval of “0” in the example shown in FIG. 8. An offset is a parameter obtained from the bitstream, and indicates a position in the range.

A bypass decoder in an image decoding device decodes the bin by comparing the offset and the range.

FIG. 9 is an explanatory diagram showing a prefix decoding process. In the example shown in FIG. 9, bins are decoded in the order of b0, b1, and b2. In the case where the offset is such a value as shown in FIG. 9, b0=1, b1=1, and b2=0 are decoded.

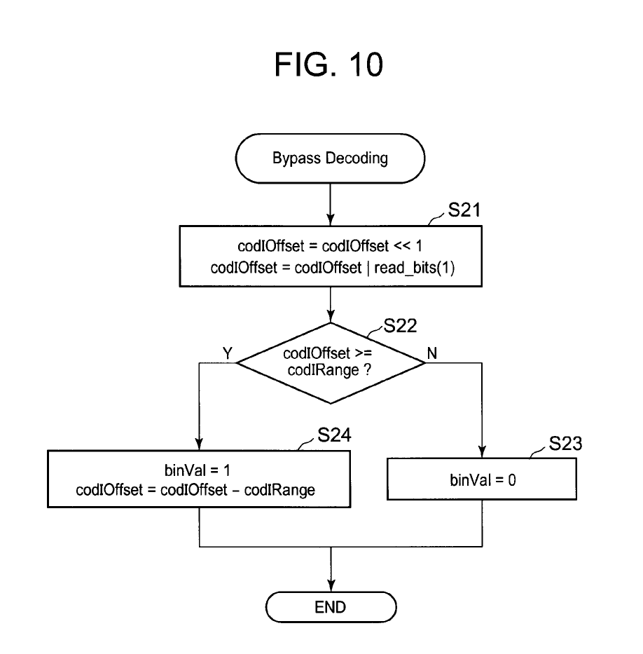

FIG. 10 is a flowchart showing bypass decoding described in 9.2.3.2.3 in NPL 1. The same process as the process shown in the flowchart in FIG. 10 is also described in Patent Literature (PTL) 1.

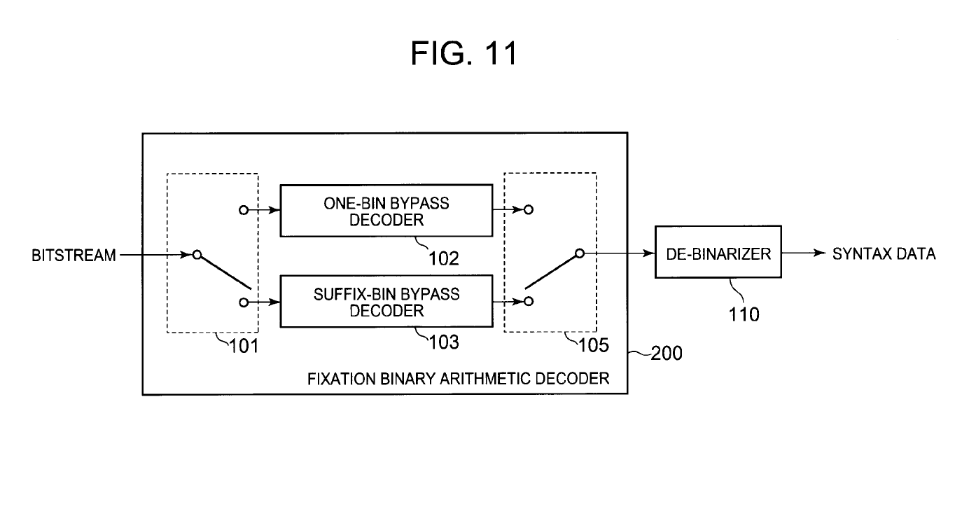

FIG. 11 is a block diagram showing a structural example of a typical fixation binary arithmetic decoder (bypass decoder) 200 for performing bypass decoding, together with a de-binarizer 110. The bypass decoder 200 shown in FIG. 11 includes: a switch 101 for switching the output destination of a bitstream; a one-bin bypass decoder 102 for receiving the bitstream via the switch 101, and performing a prefix decoding process per bin; a suffix-bin bypass decoder 103 for receiving the bitstream via the switch 101, and performing a suffix decoding process; and a switch 105 for selecting any of a prefix bin output from the one-bin bypass decoder 102 and a suffix bin output from the suffix-bin bypass decoder 103, and outputting the selected bin to the de-binarizer 110.

Referring to FIG. 10, in step S21, the one-bin bypass decoder 102 computes codIOffset=codIOffset<<1 for codIOffset which is the offset, and then computes codIOffset|read_bits(1). In detail, the one-bin bypass decoder 102 left-shifts codIOffset by 1 bit, and then takes a logical OR of codIOffset and read_bits(1). As a result of the computation process in step S21, codIOffset is doubled and also read bits(1) is added. Note that codIOffset obtained through the computation process in step S21 corresponds to the “offset” shown in FIGS. 8 and 9.

Next, in step S22, the one-bin bypass decoder 102 compares codIOffset and codIRange which is the range. In the case where codIOffset is less than codIRange, the one-bin bypass decoder 102 sets the bin to “0” (see step S23).

In the case where codIOffset is greater than or equal to codIRange, the one-bin bypass decoder 102 sets the bin to “1” (see step S24). In step S24, the one-bin bypass decoder 102 performs normalization by computing codIOffset−codIRange, for the decoding of the next bin. Suppose the bypass decoder has decoded b0 shown in FIG. 9 at this stage. Then, the computation in step S24 corresponds to a process of changing the starting point of the offset to point P (see FIG. 9). Suppose the bypass decoder has decoded b1 shown in FIG. 9 at this stage. Then, the computation in step S24 corresponds to a process of changing the starting point of the offset to point Q (see FIG. 9).

As is clear from the foregoing description, the one-bin bypass decoder 102 repeatedly performs bypass decoding per bin from the bitstream, until the terminating bin with the value “0” is decoded. The suffix-bin bypass decoder 103 decodes the number of bins of the suffix equal to the number of “1”s in the decoded prefix (NumPrefixOnes). The de-binarizer 110 converts the binary string to syntax data, and outputs the syntax data.

### CITATION LISt

### Patent Literature

PTL 1: Japanese Translation of PCT International Application Publication No. 2011-501896

### Non Patent Literature

NPL 1: “WD5: Working Draft 5 of High-Efficiency Video Coding”, Document: JCTVC-G1103_d8, Joint Collaborative Team on Video Coding (JCT-VC) of ITU-T SG16 WP3 and ISO/IEC JTC1/SC29/WG11 7th Meeting: Geneva, CH, 21-30 Nov. 2011

### SUMMARY OF INVENTION

### Technical Problem

The number of bins of the suffix (NumSuffixBin) is equal to NumPrefixOnes. The bypass decoder 200 can thus find out NumSuffixBin before decoding the suffix. Accordingly, the bypass decoder 200 completes the decoding of the suffix, simply by looking ahead NumPrefixOnes bits from the bitstream and then executing the comparison operation between the range and the offset of binary arithmetic decoding NumPrefixOnes times. To be exact, however, it is also necessary to perform the offset update process (see step S24 in FIG. 10) at most NumPrefixOnes times. In the bypass decoding described in NPL 1 or PTL 1, the suffix is decoded while utilizing the fact that the range of binary arithmetic decoding is not updated. The range of binary arithmetic decoding is not updated because each bin is bypass coded.

However, when decoding the bins of the prefix, the bypass decoder 200 cannot learn the number of bins constituting the prefix beforehand, and so cannot look ahead the bits. Hence, in the bypass decoding described in NPL 1 or PTL 1, the comparison operation between the range and the offset of binary arithmetic decoding is always performed NumPrefixOnes times, when decoding the prefix. The computational complexity when executing binary arithmetic decoding is therefore high.

The present invention has an object of reducing the computational complexity when executing binary arithmetic decoding.

### Solution to Problem

An image-data binary arithmetic decoding device according to the present invention is an image-data binary arithmetic decoding device for binary arithmetic decoding a binary string in which continuous 1s and a terminating 0 constitute a prefix, and includes continuous-one number determination means for comparing a range of binary arithmetic decoding and a binary arithmetic decoding offset obtained through looking ahead N bits from a bitstream where N is a natural number, and determining the number of continuous 1s in a binary string of the N bits.

An image-data binary arithmetic decoding method according to the present invention is an image-data binary arithmetic decoding method for binary arithmetic decoding a binary string in which continuous 1s and a terminating 0 constitute a prefix, and includes comparing a range of binary arithmetic decoding and a binary arithmetic decoding offset obtained through looking ahead N bits from a bitstream where N is a natural number, and determining the number of continuous 1s in a binary string of the N bits.

An image-data binary arithmetic decoding program according to the present invention is an image-data binary arithmetic decoding program for binary arithmetic decoding a binary string in which continuous 1s and a terminating 0 constitute a prefix, and causes a computer to execute a process of comparing a range of binary arithmetic decoding and a binary arithmetic decoding offset obtained through looking ahead N bits from a bitstream where N is a natural number, and determining the number of continuous 1s in a binary string of the N bits.

### Advantageous Effects of Invention

According to the present invention, the number of times the comparison operation between the range and the offset is performed when decoding the prefix can be reduced, so that the computational complexity when executing binary arithmetic decoding can be reduced.

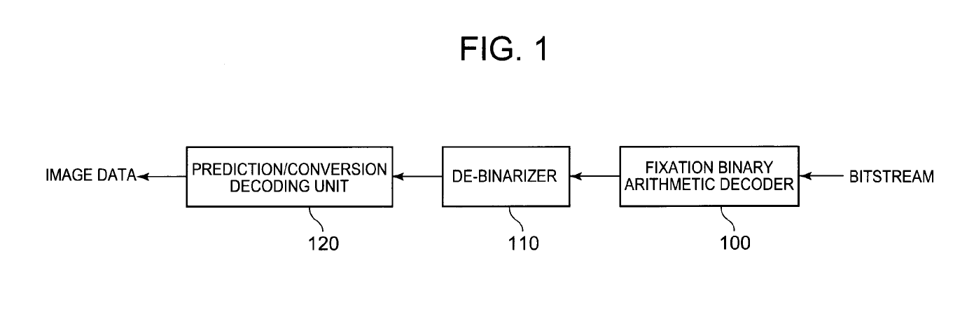

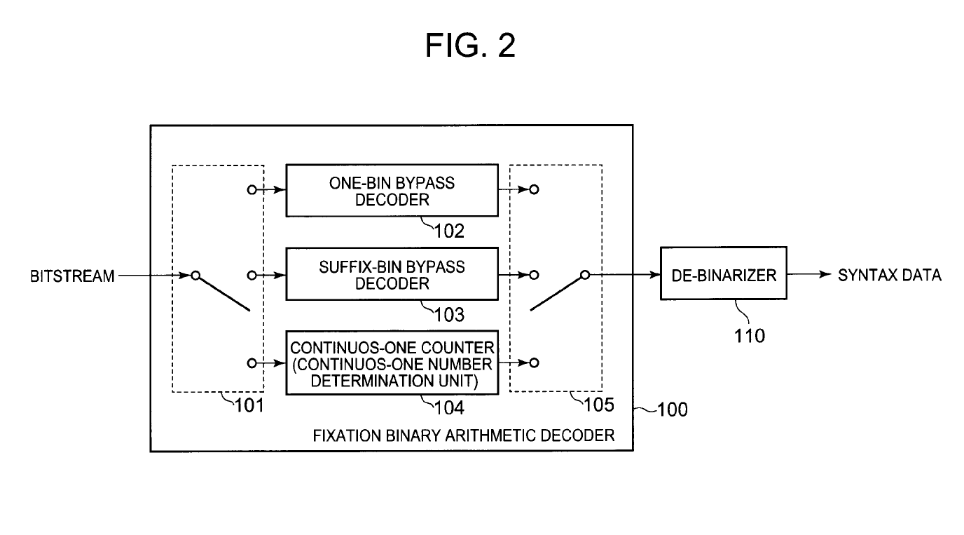

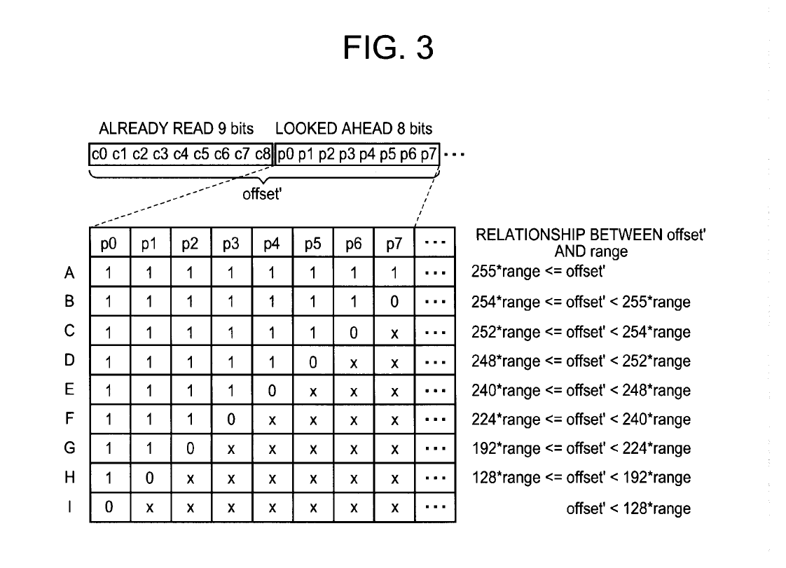

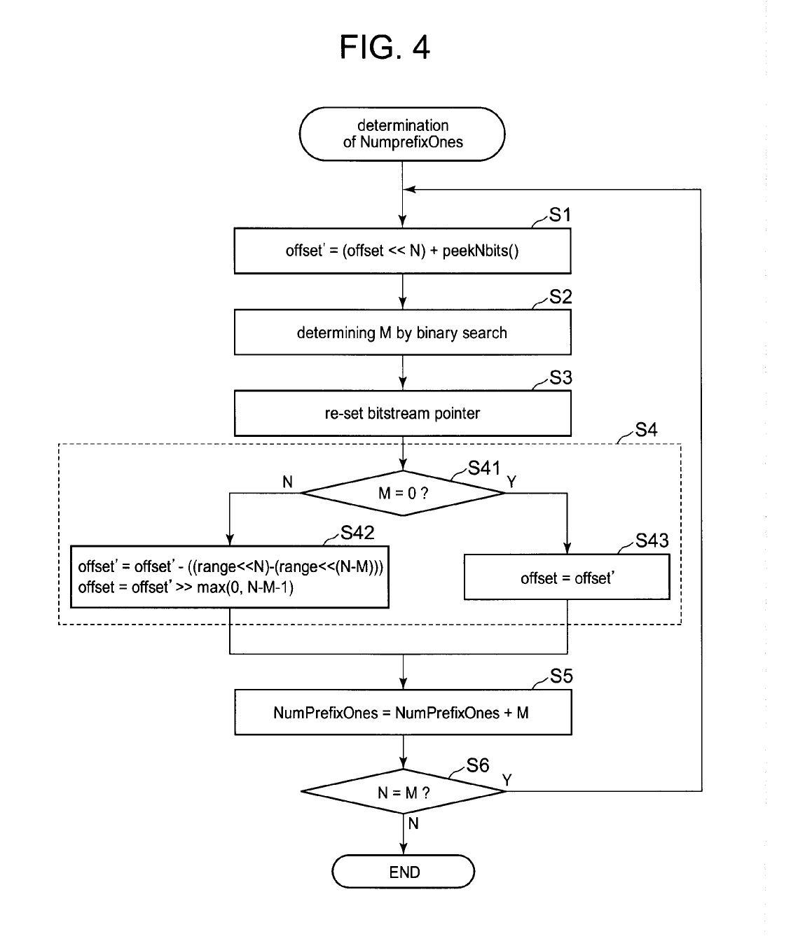

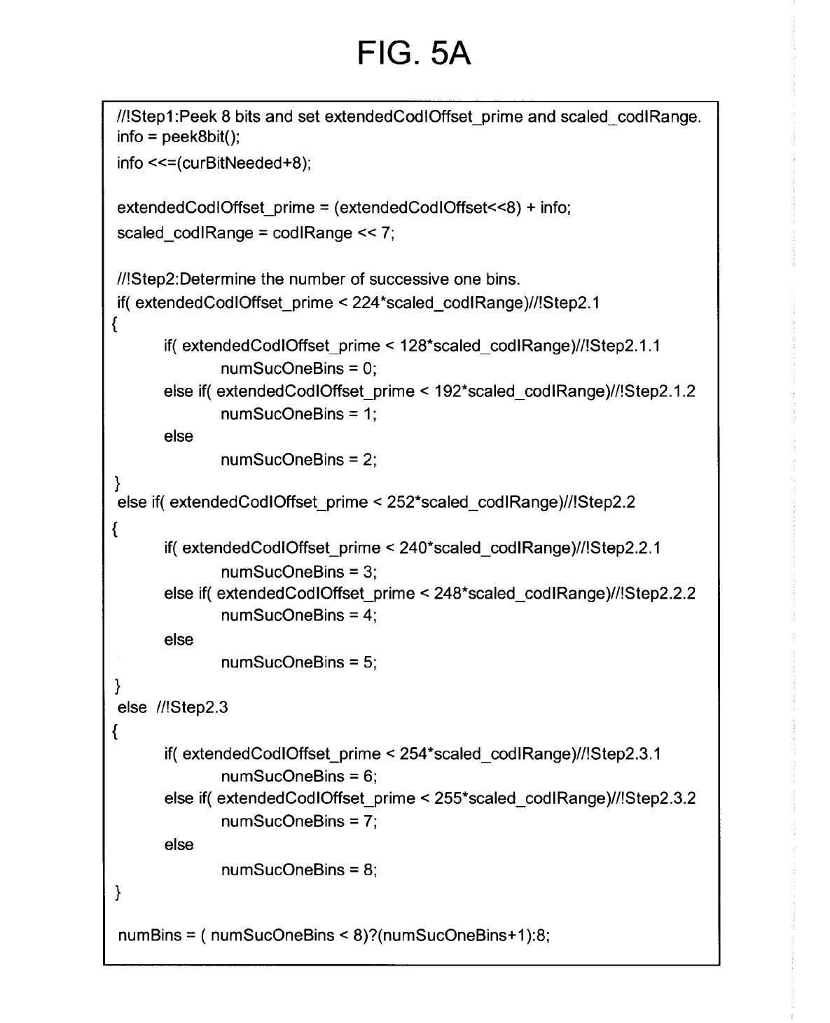

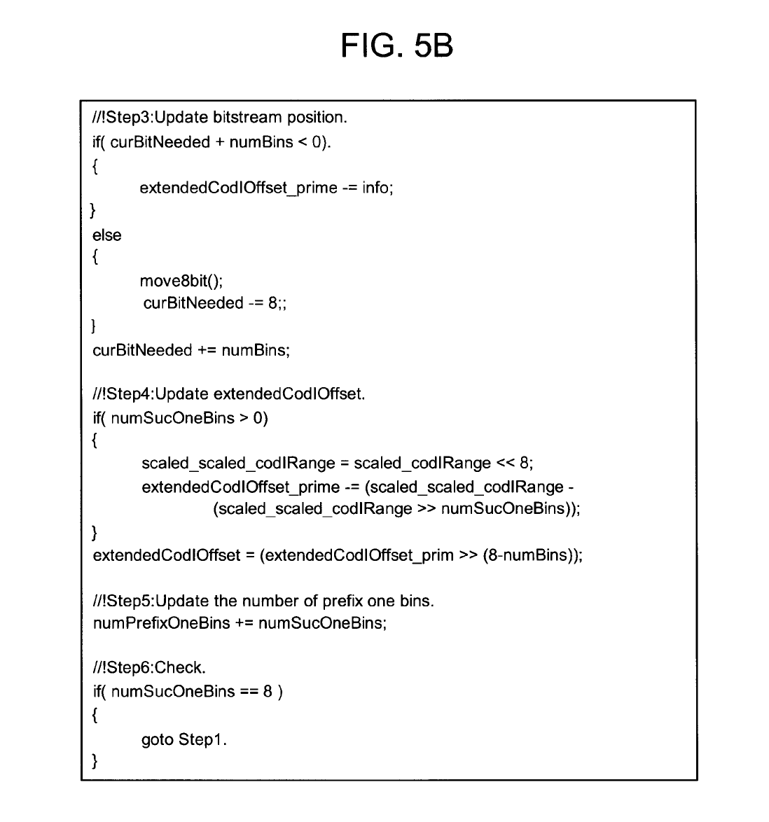

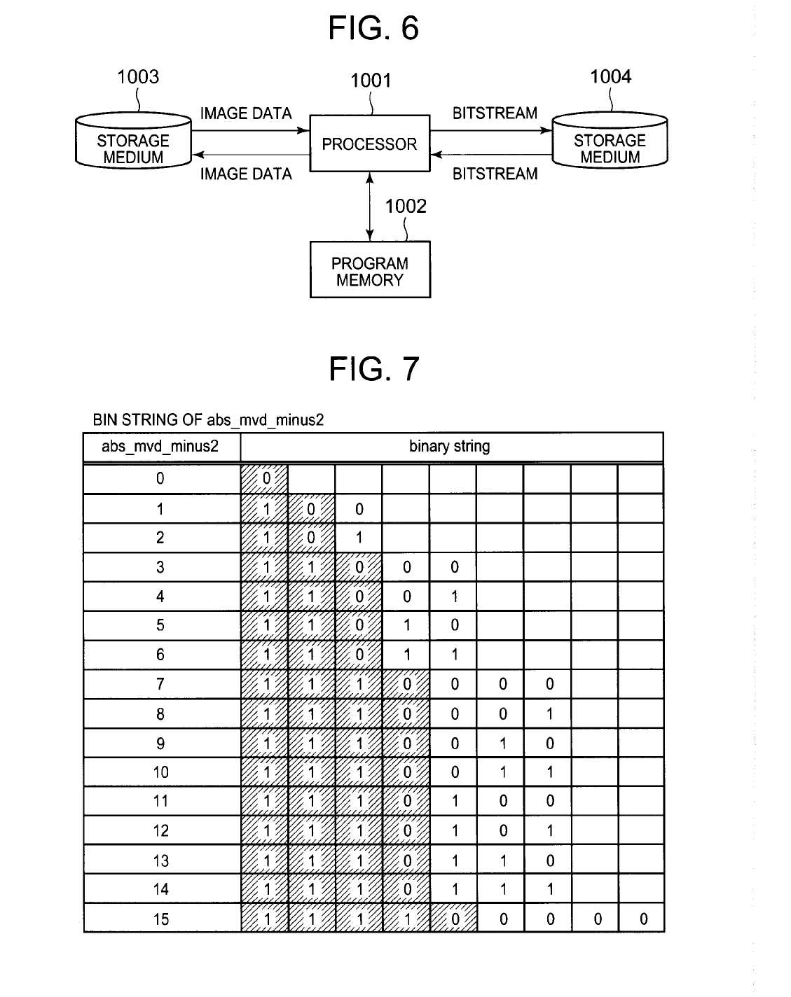

### BRIEF DESCRIPTION OF DRAWINGS

[FIG. 1] It is a block diagram showing the structure of an exemplary embodiment of an image decoding device according to the present invention.

[FIG. 2] It is a block diagram showing a structural example of a fixation binary arithmetic decoder according to the present invention.

[FIG. 3] It is an explanatory diagram showing an example of a process of determining the number of “1”s included in a prefix.

[FIG. 4] It is a flowchart showing a process of determining NumPrefixOnes by a continuous-one counter.

[FIG. 5A] It is an explanatory diagram showing pseudo code of bypass decoding.

[FIG. 5B] It is an explanatory diagram showing pseudo code of bypass decoding.

[FIG. 6] It is a block diagram showing a structural example of an information processing system capable of realizing the functions of the image decoding device according to the present invention.

[FIG. 7] It is an explanatory diagram showing a binary string for abs_mvd_minus2.

[FIG. 8] It is an explanatory diagram showing a process of decoding a bin from a bitstream.

[FIG. 9] It is an explanatory diagram showing a prefix decoding process.

[FIG. 10] It is a flowchart showing bypass decoding.

[FIG. 11] It is a block diagram showing a structural example of a typical fixation binary arithmetic decoder.

### DESCRIPTION OF EMBODIMENTS

FIG. 1 is a block diagram showing the structure of an exemplary embodiment of an image decoding device according to the present invention. The image decoding device shown in FIG. 1 includes: a fixation binary arithmetic decoder (bypass decoder) 100 corresponding to an exemplary embodiment of an image-data binary arithmetic decoding device; a de-binarizer 110; and a prediction/conversion decoding unit 120 for performing a conversion decoding process and a prediction decoding process. The image decoding device may include an adaptive binary arithmetic decoder (not shown).

FIG. 2 is a block diagram showing a structural example of the bypass decoder 100. The bypass decoder 100 shown in FIG. 2 includes: a switch 101 for switching the output destination of a bitstream; a one-bin bypass decoder 102 for receiving the bitstream via the switch 101, and performing a prefix decoding process per bin; a suffix-bin bypass decoder 103 for receiving the bitstream via the switch 101, and performing a suffix decoding process; a continuous-one counter (continuous-one number determination unit) 104 for determining the number of continuous “1”s in the bitstream; and a switch 105 for selecting any of an output of the one-bin bypass decoder 102, a suffix bin output from the suffix-bin bypass decoder 103, and a prefix bin output from the continuous-one counter 104, and outputting the selected bin to the de-binarizer 110.

In this exemplary embodiment, the continuous-one counter 104 looks ahead the bitstream, and determines the number of “1”s included in the prefix.

In this exemplary embodiment, the continuous-one counter 104 can also decode the prefix when determining the number of “1”s included in the prefix, and so the one-bin bypass decoder 102 may be omitted.

FIG. 3 is an explanatory diagram showing an example of the process of determining the number of “1”s included in the prefix. In the example shown in FIG. 3, the continuous-one counter 104 has already read 9 bits (c0, c1 ,c2, c3, c4, c5, c6, c7, c8) from the bitstream, and further looks ahead 8 bits (p0, p1, p2, p3, p4, p5, p6, p7). Note that A to I in the right margin of the lower section in FIG. 3 are signs used for the sake of convenience to identify the corresponding elements in the case where each row is regarded as an element.

As shown in FIG. 3, 17-bit data (p7 is the least significant bit (LSB)) made up of the already read 9 bits and the looked ahead 8 bits is set as an offset′, and a value obtained by multiplying a range by (2^{N}−1) (N is the number of looked ahead bits) is set as a weighted range. In the example shown in FIGS. 3, N=8, (2^{N}−1)=255, and range=0.5. In FIG. 3, “x” indicates “1” or “0”.

In the case where the looked ahead 8 bits are all “1”, 255*range<=offset′ holds true regardless of the values of the already read 9 bits (c0, c1, c2, c3, c4, c5, c6, c7, c8), as shown in the top row in the lower section in FIG. 3. Here, “<=” denotes “greater than or equal to”. In the case where p0 which is the most significant bit (MSB) of the looked ahead 8 bits is “0”, offset′<128 range holds true regardless of the values of the already read 9 bits (c0, c1, c2, c3, c4, c5, c6, c7, c8), as shown in the bottom row in the lower section in FIG. 3.

For the value shown in each row between the top and bottom rows in the lower section in FIG. 3, the relationship shown outside the lower section in FIG. 3 holds true.

The continuous-one counter 104 determines the number of “1”s included in the prefix, using the relationship exemplified in FIG. 3.

The following point is noted: since the prefix is made up of continuous “1”s and a terminating “0”, the range of possible value of the offset of binary arithmetic decoding is limited as shown in FIG. 3, that is, the range of possible value of the offset of binary arithmetic decoding is not 2^{N}+1 but N+1 even when N bits (N is a natural number) are looked ahead. Moreover, as the number of continuous “1”s increases, the upper limit of the offset′ increases according to a power of 2 (2^{7-m}) corresponding to the position m of “0”, as is clear from FIG. 3. Therefore, the number of continuous “1”s in the binary string included in the N bits can be determined by performing comparison log₂(N+1) times by the method based on binary search, without the comparison of the range of value of N+1 being performed N times as described in NPL 1.

Accordingly, in prefix decoding, the bypass decoder 100 looks ahead predetermined N bits, and compares the range of binary arithmetic decoding and the offset (i.e. offset') obtained through looking ahead the N bits log₂(N+1) times, to determine the number of continuous “1”s in the binary string included in the N bits. In the case where the terminating “0” is not found in the looked ahead N bits, looking ahead the next N bits may be repeated to accumulate the number of continuous “1”s until the terminating “0” is found.

The following describes the operation of the continuous-one counter 104. FIG. 4 is a flowchart showing the process of determining NumPrefixOnes by the continuous-one counter 104.

Suppose the initial value of NumPrefixOnes is “0”. In step S1, the continuous-one counter 104 computes offset′=(offset<<N)+peekNbits( ). In detail, the continuous-one counter 104 left-shifts the offset by N bits, and sets N bits looked ahead from the bitstream as lower-order bits, to obtain the offset′. Here, peekNbits( ) denotes a function of looking ahead N bits from the bitstream.

In step S2, the continuous-one counter 104 determines the number of continuous bins of N bits. In detail, the continuous-one counter 104 compares the offset′ and the weighted range to determine M, by binary search. In the case where N=8 (see FIG. 3), the continuous-one counter 104 determines M by binary search in the following manner.

(step S2.1) The continuous-one counter 104 determines whether or not the offset′ is less than (224* range). Here, (224*range) corresponds to the center element (specifically, the lower limit of the center element) of the array A to I exemplified in FIG. 3. Since the number of elements is “9” in the example shown in FIG. 3, (224*range) corresponds to the fourth element F from the bottom. In the case where the offset′ is less than (224*range), the continuous-one counter 104 advances to step S2.1.1. In the case where the offset′ is greater than or equal to (224*range), the continuous-one counter 104 advances to step S2.2.

(step S2.1.1) The continuous-one counter 104 determines whether or not the offset′ is less than (128 range). In the case where the offset′ is less than (128 range), the continuous-one counter 104 sets M=0 (see the bottom row in the lower section in FIG. 3). The continuous-one counter 104 then advances to step S3. In the case where the offset′ is greater than or equal to (128* range), the continuous-one counter 104 advances to step S2.1.2. Here, (128*range) corresponds to the center element between the element I at the bottom row and the third element G from the bottom in FIG. 3.

(step S2.1.2) The continuous-one counter 104 determines whether or not the offset′ is less than (192 range). In the case where the offset′ is less than (192 range), the continuous-one counter 104 sets M=1 (see the second row from the bottom in the lower section in FIG. 3). The continuous-one counter 104 then advances to step S3. In the case where the offset′ is greater than or equal to (192*range), the continuous-one counter 104 sets M=2 (see the third row from the bottom in the lower section in FIG. 3). The continuous-one counter 104 then advances to step S3. Here, (192*range) corresponds to the center element between the element F and the element H in FIG. 3.

(step S2.2) The continuous-one counter 104 determines whether or not the offset′ is less than (252 range). In the case where the offset′ is less than (252 range), the continuous-one counter 104 advances to step S2.2.1. In the case where the offset′ is greater than or equal to (252*range), the continuous-one counter 104 advances to step S2.3. Here, (252 range) corresponds to the center element between the element A at the top row and the element F in FIG. 3.

(step S2.2.1) The continuous-one counter 104 determines whether or not the offset′ is less than (240 range). In the case where the offset′ is less than (240 range), the continuous-one counter 104 sets M=3 (see the fourth row from the bottom in the lower section in FIG. 3). The continuous-one counter 104 then advances to step S3. In the case where the offset′ is greater than or equal to (240*range), the continuous-one counter 104 advances to step S2.2.2. Here, (240*range) corresponds to the center element between the element D and the element F in FIG. 3.

(step S2.2.2) The continuous-one counter 104 determines whether or not the offset′ is less than (248 range). In the case where the offset′ is less than (248 range), the continuous-one counter 104 sets M=4 (see the fifth row from the top in the lower section in FIG. 3). The continuous-one counter 104 then advances to step S3. In the case where the offset′ is greater than or equal to (248*range), the continuous-one counter 104 sets M=5 (see the fourth row from the top in the lower section in FIG. 3). The continuous-one counter 104 then advances to step S3.

(step S2.3)

(step S2.3.1) The continuous-one counter 104 determines whether or not the offset′ is less than (254* range). In the case where the offset′ is less than (254* range), the continuous-one counter 104 sets M=6 (see the third row from the top in the lower section in FIG. 3). The continuous-one counter 104 then advances to step S3. In the case where the offset′ is greater than or equal to (254*range), the continuous-one counter 104 advances to step S2.3.2. Here, (254*range) corresponds to the center element between the element A and the element C in FIG. 3.

(step S2.3.2) The continuous-one counter 104 determines whether or not the offset′ is less than (255 range). In the case where the offset′ is less than (255 range), the continuous-one counter 104 sets M=7 (see the second row from the top in the lower section in FIG. 3). The continuous-one counter 104 then advances to step S3. In the case where the offset′ is greater than or equal to (255*range), the continuous-one counter 104 sets M=8 (see the top row in FIG. 3). The continuous-one counter 104 then advances to step S3.

Through the above-mentioned binary search, the number of continuous “1”s included in the looked ahead 8 bits is determined by at most four determination operations.

In step S3, the continuous-one counter 104 updates the bit position in the bitstream. In detail, in the case where M=N (corresponding to the case where the terminating “0” is not found), the continuous-one counter 104 moves the bit position in the bitstream forward by N. The continuous-one counter 104 then advances to step S4. In the case where M≠N (corresponding to the case where the terminating “0” is found), the continuous-one counter 104 moves the bit position in the bitstream forward by M+1. The continuous-one counter 104 then advances to step S4.

In step S4, the continuous-one counter 104 updates the offset according to the value of M. In detail, in the case where M is not 0 (corresponding to the case where one or more continuous “1” bins are present), the continuous-one counter 104 updates the offset′ as follows (steps S41, S42):

offset′=offset′−((range<<N)−(range<<(N−M))).

The right side of the equation corresponds to the normalization (i.e. the subtraction of the range) of the offset performed the number of times equal to the number of continuous “1” bins. The continuous-one counter 104 further updates the offset based on the offset′ as follows:

offset=offset′>>max(0, N−M−1)

where max(a, b) is a function of returning a larger value of inputs a and b.

In the case where M is 0 (corresponding to the case where one or more continuous “1” bins are not present), the continuous-one counter 104 sets the offset′ as the offset (steps S41, S43).

In step S5, the continuous-one counter 104 updates NumPrefixOnes. In detail, the continuous-one counter 104 increments NumPrefixOnes by M.

In step S6, the continuous-one counter 104 determines the value of M. In the case where M is N (=8), the continuous-one counter 104 returns to step S1. In the case where M is less than N (=8), the continuous-one counter 104 ends the process.

In this exemplary embodiment, the number of times the comparison operation between the range and the offset of binary arithmetic decoding is performed in prefix decoding is log₂(N+1). Thus, the number of times the comparison operation is performed can be reduced by N−log₂(N+1), compared to the conventional techniques.

FIGS. 5A and 5B are each an explanatory diagram showing pseudo code for realizing the process described above. The pseudo code is based on the assumptions given below.

1) The number of normal looked ahead bits for the offset is 7 bits, and the number of looked ahead bits for the prefix is 8 bits.

2) The following variables are defined:

extendedCodlOffset: 7-bit extended offset, i.e. offset′(9+7=16 bits);

codIRange: range; and

curBitNeeded: (the number of offset invalid LSB bits)−8, where curBitNeeded=−8 denotes all 16 bits are valid, curBitNeeded=−7 denotes 15 MSB bits are valid, and curBitNeeded =−1 denotes 9 MSB bits are valid.

The exemplary embodiment described above may be realized by hardware, or may be realized by a computer program.

FIG. 6 is a block diagram showing a structural example of an information processing system capable of realizing the functions of the image decoding device according to the present invention. The information processing system shown in FIG. 6 includes: a processor 1001; a program memory 1002; a storage medium 1003 for storing image data; and a storage medium 1004 for storing a bitstream. The storage medium 1003 and the storage medium 1004 may be separate storage media, or storage areas included in the same storage medium. As a storage medium, a magnetic storage medium such as a hard disk is available.

In the information processing system shown in FIG. 6, a program for realizing the functions of the blocks shown in each of FIGS. 1 and 2 is stored in the program memory 1002. The processor 1001 realizes the functions of the image decoding device shown in FIG. 1 and the bypass decoder 100 shown in FIG. 2, by executing processes according to the program stored in the program memory 1002.

Though the present invention has been described with reference to the above exemplary embodiment and examples, the present invention is not limited to the above exemplary embodiment and examples. Various changes understandable by those skilled in the art can be made to the structures and details of the present invention within the scope of the present invention.

This application claims priority based on Japanese Patent Application No. 2012-183229 filed on Aug. 22, 2012, the disclosure of which is incorporated herein in its entirety.

### REFERENCE SIGNS LIST

100 fixation binary arithmetic decoder (bypass decoder)

101 switch

102 one-bin bypass decoder

103 suffix-bin bypass decoder

104 continuous-one counter (continuous-one number determination unit)

105 switch

110 de-binarizer

120 prediction/conversion decoding unit

200 fixation binary arithmetic decoder (bypass decoder)

1001 processor

1002 program memory

1003 storage medium

1004 storage medium

1. An image-data binary arithmetic decoding device for binary arithmetic decoding a binary string in which continuous 1s terminated by 0 constitute a prefix, the image-data binary arithmetic decoding device comprising:
a continuous-one number determination unit which compares a range of binary arithmetic decoding and a binary arithmetic decoding offset obtained through looking ahead N bits from a bitstream where N is a natural number, and determining the number of continuous 1s in a binary string of the N bits.

2. The image-data binary arithmetic decoding device according to claim 1, wherein the continuous-one number determination unit determines the number of continuous 1s by binary search, while comparing the range and the offset.

3. An image decoding device for binary arithmetic decoding a binary string in which continuous 1s and a terminating 0 constitute a prefix, the image decoding device comprising:
the image-data binary arithmetic decoding device according to claim 1.

4. An image-data binary arithmetic decoding method for binary arithmetic decoding a binary string in which continuous 1s and a terminating 0 constitute a prefix, the image-data binary arithmetic decoding method comprising:
comparing a range of binary arithmetic decoding and a binary arithmetic decoding offset obtained through looking ahead N bits from a bitstream where N is a natural number, and determining the number of continuous 1s in a binary string of the N bits.

5. The image-data binary arithmetic decoding method according to claim 4, wherein the number of continuous 1s is determined by binary search, while comparing the range and the offset.

6. A non-transitory computer readable information recording medium storing an arithmetic decoding program, for binary arithmetic decoding a binary string in which continuous 1s and a terminating 0 constitute a prefix, when executed by a processor, performs
comparing a range of binary arithmetic decoding and a binary arithmetic decoding offset obtained through looking ahead N bits from a bitstream where N is a natural number, and determining the number of continuous 1s in a binary string of the N bits.

7. The computer readable information recording medium according to claim 6, wherein
the number of continuous 1s is determined by binary search, while comparing the range and the offset.

8. An image decoding device for binary arithmetic decoding a binary string in which continuous 1s and a terminating 0 constitute a prefix, the image decoding device comprising:
the image-data binary arithmetic decoding device according to claim 2.
